(19) United States
(12) Patent Application Publication
(10) Pub. No.: US 2017/0045621 A1
(43) Pub. Date: Feb. 16, 2017

(54) SATELLITE POSITIONING DEVICE AND ELECTRONIC DEVICE

(71) Applicant: REALTEK SEMICONDUCTOR CORP., HSINCHU (TW)

(72) Inventors: Wei-Hung He, Hsinchu City (TW); Kuang-Yu Yen, Zhubei City (TW)

(21) Appl. No.: 15/060,068

(22) Filed: Mar. 3, 2016

(30) Foreign Application Priority Data
Aug. 13, 2015 (TW) 104126336

(51) Int. Cl. G01S 19/09

(52) U.S. Cl. CPC G01S 19/09

(57) ABSTRACT

The present disclosure provides a satellite positioning device which includes a first short-distance transceiver module and a first satellite positioning device. The first short-distance transceiver module is configured to wirelessly connect to a second short-distance transceiver module of an electronic device, and to receive satellite positioning information from the second short-distance transceiver module. The first satellite positioning module is electrically coupled to the first short-distance transceiver module and is configured to receive at least one satellite signal. The first satellite positioning module generates a first satellite positioning result according to the at least one satellite signal and the satellite positioning information received by the first short-distance transceiver module.

### CROSS-REFERENCE TO RELATED APPLICATION

This application claims priority to Taiwan Patent Application No. 104126336, filed on Aug. 13, 2015. in the Taiwan Intellectual Property Office, the disclosure of which is incorporated herein in its entirety by reference.

### BACKGROUND OF THE INVENTION

1. Field of the Invention

The present disclosure relates to a satellite positioning system, and, more specifically, the present disclosure utilizes a positioning device and an electronic device in the satellite positioning system to improve the performance of the satellite positioning.

2. Description of the Related Art

In general, the global satellite positioning system, such as Global Navigation Satellite System (GLONASS), Global Position System (GPS), etc., calculates a position of the receiver based on positions of the satellites and the measured Pseudorange, where the positions of the satellites are obtained based on the Ephemeris received by the Global Navigation Satellite System (GNSS) receiver. However, due to the limitation of the data transmission speed between the satellites and the receiver, about 30 seconds are needed for the conventional receiver to collect the complete Ephemeris in the first fix, and therefore the need for immediately obtaining the position is unable to be satisfied.

In order to improve the efficiency of positioning, the GNSS receiver is configured to connect to the global network to reduce the time for positioning by utilizing the assisted global position system. However, not all the GNSS receivers mounted with the satellite positioning module are capable of accessing to the internet network. For example, the common wearable mobile devices or event data recorders nowadays are not capable of accessing to the internet network.

### SUMMARY OF THE INVENTION

For solving the above-mentioned problem, an aspect of the present disclosure is to provide a satellite positioning device, which includes a first short-distance transceiver module and a first satellite positioning module. The first short-distance transceiver module is configured to wirelessly connect to a second short-distance transceiver module of an electronic device, and to receive satellite positioning information from the second short-distance transceiver module. The first satellite positioning module is electrically coupled to the first short-distance transceiver module, and is configured to receive at least one satellite signal, and to generate a first satellite positioning result according to the at least one satellite positioning signal and the satellite positioning information received by the first short-distance transceiver module.

Another aspect of the present disclosure provides an electronic device, which is configured to assist a satellite positioning device to generate a first satellite positioning result according to at least one first satellite signal. The satellite positioning device has a first short-distance transceiver module and a first satellite positioning module coupled to each other. The electronic device includes a second satellite positioning module and a second short-distance transceiver module. The second satellite positioning module is configured to receive at least one second satellite signal to generate satellite positioning information. The second short-distance transceiver module is configured to transmit the satellite positioning information to the first short-distance transceiver module. The first satellite positioning module generates a first satellite positioning result according to the at least one first satellite signal and the satellite positioning information received by the first short-distance transceiver module.

Yet another aspect of the present disclosure provides an electronic device, which is configured to assist a satellite positioning device to generate a first satellite positioning result according to at least one first satellite signal. The satellite positioning device has a first short-distance transceiver module and a first satellite positioning module coupled to each other. The electronic device includes a wireless network module and a second short-distance transceiver module. The wireless network module is configured to receive satellite positioning information generated by another electronic device, and the second short-distance transceiver module is configured to transmit the satellite positioning information to the first short-distance transceiver module. The first satellite positioning module generates the first satellite positioning result according to the at least one first satellite signal and the satellite positioning information received by the first short-distance transceiver module.

Based on those mentioned above, the satellite positioning device provided by the present disclosure utilizes the short-distance transceiver modules and receives the satellite positioning information or the satellite positioning result from the electronic device. Thus, the Time To First Fix (TTFF) of the satellite positioning device of the present disclosure is significantly decreased, and the satellite positioning device without the capability of accessing to the internet network is provided with the AGPS-like function such that the power consumption and the cost of the satellite positioning device are further reduced.

### BRIEF DESCRIPTION OF THE DRAWINGS

Hereinafter, the above and other features and embodiments of the present disclosure are described in detail with reference to the accompanying drawings.

FIG. 1 is a schematic diagram of a satellite positioning system according to a first embodiment of the present disclosure.

FIG. 2 is a schematic diagram of a satellite positioning system according to a second embodiment of the present disclosure.

FIG. 3 is a schematic diagram of a satellite positioning system according to a third embodiment of the present disclosure.

FIG. 4 is a method flow chart of a satellite positioning system according to the first embodiment of the present disclosure.

FIG. 5 is a method flow chart of a satellite positioning system according to the second embodiment of the present disclosure.

FIG. 6 is a method flow chart of a satellite positioning system according to the third embodiment of the present disclosure.

### DETAILED DESCRIPTION OF THE PREFERRED EMBODIMENTS

In order to facilitate the understanding of the technical features, the contents and advantages of the present disclosure, and the effectiveness thereof that can be achieved, the present disclosure are illustrated in detail below through embodiments with reference to the accompanying drawings. On the other hand, the diagrams used herein are merely intended to be schematic and auxiliary to the specification, but are not necessary to be true scale and precise configuration after implementing the present disclosure. Thus, it should not be interpreted in accordance with the scale and the configuration of the accompanying drawings to limit the scope of the present disclosure on the practical implementation.

In the following description and claims, the terms “coupled” and “connected” may be used. In particular embodiments, “connected” and “coupled” may be used to indicate that two or more elements are in direct physical or electrical contact with each other, or may also mean that two or more elements may be in indirect physical or electrical contact with each other.

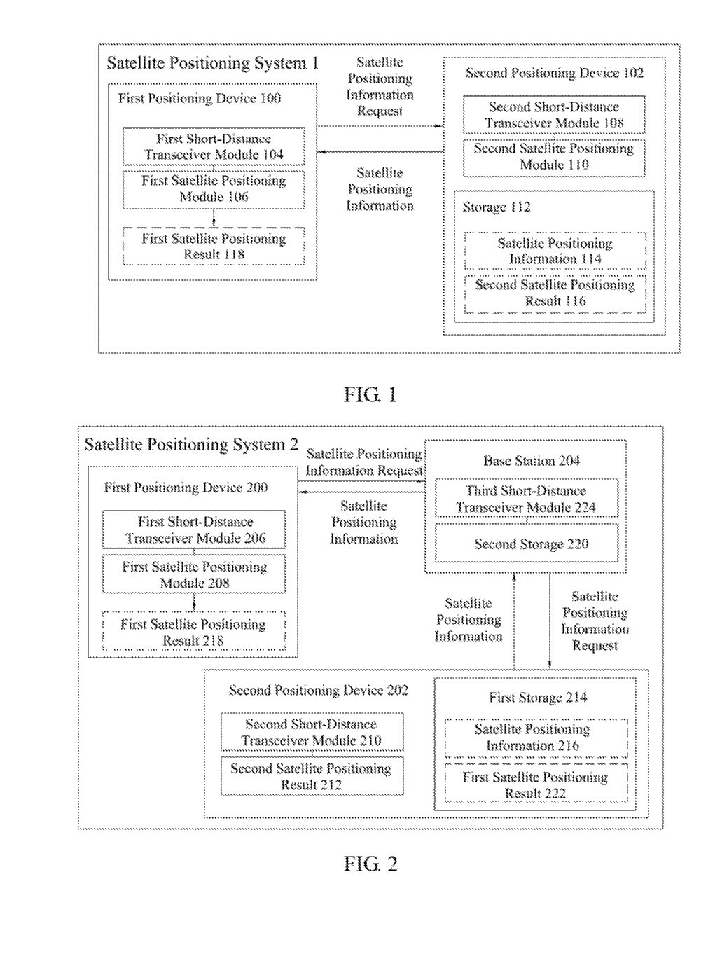

FIG. 1 is a schematic diagram of a satellite positioning system 1 according to a first embodiment of the present disclosure. As shown in FIG. 1, the satellite positioning system 1 includes a first positioning device 100 and a second positioning device 102. The first positioning device 100 includes a first short-distance transceiver module 104 and a first satellite positioning module 106, and the first satellite positioning module 106 is electrically connected to the first short-distance transceiver module 104. The first satellite positioning module 106 is configured to receive a plurality of satellite signals to perform the first-time positioning and get a position (called first fix hereinafter). Here, the first satellite positioning module 106 usually includes a receiver which is capable of receiving the satellite signals, and the receiver may utilize different functions and precisions depending on different purposes. In addition, in some embodiments, the first satellite positioning module 106 includes at least one antenna, a data processor, a display and a power supply, and the above-mentioned equipments are normally integrated to be a complete entity by those skilled in the art. When the first satellite positioning module 106 is used to perform the first fix, the first short-distance transceiver module 104 is configured to wirelessly transmit a satellite positioning information request to obtain the satellite positioning information through the first short-distance transceiver module 104, so as to improve the speed of the first fix under the premise that the first positioning device 100 is not capable of accessing the internet network. Here, the satellite positioning information may be Ephemeris, reference time, reference positions or information needed for positioning.

In some embodiments, the plurality of satellite signals may be regarded as a single satellite signal. For example, the satellite signals of different satellites are transmitted based on the Code Division Multiple Access (CDMA) technique, that is, the satellite signals are transmitted in the code domain, and the transmitted satellite signals are actually a time domain signal generated by superpositioning the satellite signals from different satellites. Therefore, the plurality of satellite signals received by the receiver may be regarded as a single satellite signal.

The second positioning device 102 includes a second short-distance transceiver module 108, a second satellite positioning module 110 and a storage 112. The second short-distance transceiver module 108 may be paired with the first short-distance transceiver module 104 in advance, or the pairing process may be triggered as the first positioning device 100 has the pairing request. The second short-distance transceiver module 108 is configured to receive the satellite positioning information request transmitted by the first short-distance transceiver module 104. Here, as the first satellite positioning module 106 performs the first fix, the second satellite positioning module 110 has received the plurality of satellite signals to generate satellite positioning information 114, in which the storage 112 stores the satellite positioning information 114. It is noted that although the storage is not specifically described to be included in the first positioning device 100, there is the built-in storage known by those skilled in the art, and the detailed description thereof is omitted.

In the embodiment, the satellite positioning information request is transmitted to the second short-distance transceiver module 108 from the first short-distance transceiver module 104 as the first fix is performed by the first satellite positioning module 106. After the second short-distance transceiver module 108 receives the satellite positioning information request, the satellite positioning information 114 stored in the storage 112 is transmitted to the first short-distance transceiver module 104, and the first satellite positioning module 106 performs the first fix according to the received satellite positioning information 114 and the plurality of satellite signals so as to generate a first satellite positioning result 118.

Specifically, the first aspect of the satellite positioning system of the present disclosure provides the first positioning device 100 and the second positioning device 102 both with the satellite positioning modules and the capability of short-distance connection. The first positioning device 100 requests a connection to the second positioning device 102 via the first short-distance transceiver module 104. If the second satellite positioning module 110 of the second positioning device 102 completes the positioning or has the satellite positioning information (e.g., Ephemeris) within a valid time, the second positioning device 102 transmits the satellite positioning information 114 to the first positioning device 100 after the connection between the first short-distance transceiver module 104 and the second positioning device 102 is established. And the first satellite positioning module 106 receives the satellite positioning information 114 through the first short-distance transceiver module 104, such that the satellite positioning information 114 including Ephemeris could be obtained.

Here, the first satellite positioning module 106 includes a processor configured to determine whether the received satellite positioning information 114 is within the valid time, i.e., whether the received satellite positioning information 114 is available to use. Furthermore, in the period when the first fix is performed, when the first satellite positioning module 106 waits for the first short-distance transceiver module 104 to receive the satellite positioning information, the first satellite positioning module 106 receives the plurality of satellite signals at the same time such that the Time To First Fix (TTFF) could be minimized.

In addition, if the satellite positioning is completed by the second satellite positioning module 110, and a second satellite positioning result 116 is generated before the first fix is performed by the first satellite positioning module 106, the first satellite positioning module 106 may directly receive the second satellite positioning result 116 through the first short-distance transceiver module 104. After the second satellite positioning result 116 is identified to be within a valid time, the second satellite positioning result 116 received by the first short-distance transceiver module 104 may be directly served as the first satellite positioning result 118. By the configuration of the system, the available satellite positioning information around the first positioning device 100 could be utilized efficiently and the TTFF of the first positioning device 100 would be reduced significantly.

In some embodiments, the roles of the first positioning device 100 and the second positioning device 102 may be exchanged. That is, before the first fix is performed by the second positioning device 102, if the positioning is completed by the first positioning device 100, the second short-distance transceiver module 108 may transmit the satellite positioning information request to the first positioning device 100, and the second satellite positioning module 106 may utilize the satellite positioning information or the first satellite positioning result 118 generated by the first satellite positioning module 106, such that the TTFF of second positioning device 102 could be decreased.

FIG. 2 is a schematic diagram of the satellite positioning system 2 according to a second embodiment of the present disclosure. As shown in FIG. 2, the satellite positioning system 2 includes a first positioning device 200, a second positioning device 202 and a base station 204. The first positioning device 200 includes a first short-distance transceiver module 206 and a first satellite positioning module 208. The second positioning device 202 includes a second short-distance transceiver module 210, a second satellite positioning module 212, and a first storage 214. The base station 204 includes a third short-distance transceiver module 224 and a second storage 220.

The first positioning device 200 and the second positioning device 202 are respectively similar to the first positioning device 100 and the second positioning device 102 described in the afore-mentioned embodiment, and therefore the repeated detailed description is omitted. The difference between the present embodiment and the first embodiment is that the pairing and the data transmission are not direct between the first positioning device 200 and the second positioning device 202, and the information is exchanged through the base station 204.

Specifically, the third short-distance transceiver module 224 of the base station 204 pairs with the first short-distance transceiver module 206 and the second short-distance transceiver module 210 respectively. As the first satellite positioning module 208 performs the first fix, the first short-distance transceiver module 206 transmits the satellite positioning information request to the second short-distance transceiver module 210 through the third short-distance transceiver module 224 of the base station 204. After the second short-distance transceiver module 210 receives the satellite positioning information request, the satellite positioning information 216 stored in the first storage 214 is transmitted to the first short-distance transceiver module 206 through the third short-distance transceiver module 224 of the base station 204, and the first satellite positioning module 208 generates a first satellite positioning result 218 according to the received satellite positioning information 216 and the plurality of satellite signals.

The satellite positioning system 2 has two operation modes. First, the second satellite positioning module 212 completes the positioning, or the generated satellite positioning information 216 (e.g., Ephemeris information) is stored in the first storage 214. In this case, as the second positioning device 202 approaches the base station 204, the connection between the second positioning device 202 and the base station 204 is being established, and the pairing is triggered. The satellite positioning information 216 may be uploaded to the second storage 220 of the base station 204 by the second short-distance transceiver module 210. As the first satellite positioning module 208 of the first satellite positioning device 200 approaches the base station 204 and has the request for positioning, the first short-distance transceiver module 206 transmits the connection request to the third short-distance transceiver module 224 of the base station 204. Once the connection between the first short-distance transceiver module 206 and the base station 204 is established, the base station 204 transmits the relevant satellite positioning information 216 to the first short-distance transceiver module 206. Thus, the first satellite positioning module 208 could generate the first satellite positioning result 218 according to the satellite positioning information 216 and the satellite signal received by the first positioning device 200.

Alternatively, if the second satellite positioning module 212 completes the positioning, the second satellite positioning result 222 is pre-transmitted to the second storage 220 of the base station 204. In this case, the built-in processor of the first satellite positioning module 208 my determine whether the second satellite positioning, result 222 is within a valid time. If the second satellite positioning result 222 is within a valid time, the second satellite positioning result 222 is directly served as the first satellite positioning result 218.

Second, as the first positioning device 200 and the second positioning device 202 are both stayed paired with the base station 204, and the second positioning device 202 performs positioning by using the second satellite positioning module 212, if the first positioning device 200 has the request for positioning, the satellite positioning information request may be transmitted to the second positioning device 202 through the third short-distance transceiver module 224 of the base station 204. After the second short-distance transceiver module 210 receives the satellite positioning information request, the first satellite positioning information 218 is transmitted to the first positioning device 200 through the third short-distance transceiver module 224 of the base station 204, or the second satellite positioning result 222 is directly transmitted to the first positioning device 200 for the first fix implemented by the first satellite positioning module 208.

Compared to the first embodiment, a network capable of providing the satellite positioning information could be established in the satellite positioning system 2 according to the need of the users, such that the exchangeability of information is further improved.

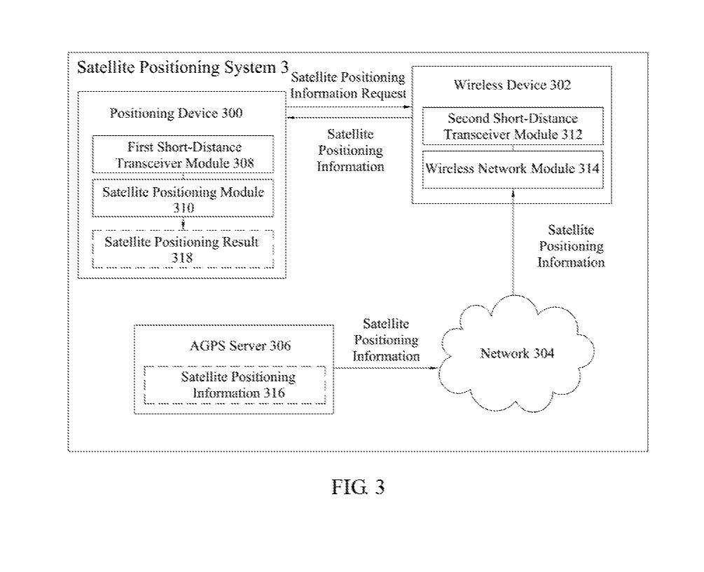

FIG. 3 is a schematic diagram of the satellite positioning system according to a third embodiment of the present disclosure. As shown in FIG. 3, the satellite positioning system 3 includes a positioning device 300, a wireless device 302, a network 304 and an AGPS server 306.

The positioning device 300 includes a first short-distance transceiver module 308 and a satellite positioning module 310. The first short-distance transceiver module 308 is configured to pair with another short-distance transceiver module and to transmit or receive information in between. The satellite positioning module 310 is electrically connected to the first short-distance transceiver module 308 and receives the plurality of satellite signals to perform the first fix.

The wireless device 302 includes a second short-distance transceiver module 312 and a wireless network module 314. The second short-distance transceiver module 312 is configured to receive the satellite positioning information request from the first short-distance transceiver module 308. The wireless network module 314 is electrically connected to the second short-distance transceiver module 312 and configured to connect to the AGPS server 306 through the network 304, in which the AGPS server 306 stores the satellite positioning information 316.

As the satellite positioning module 310 performs the first fix, the first short-distance transceiver module 308 transmits the satellite positioning information request to the second short-distance transceiver module 312. After the second short-distance transceiver module 312 receives the satellite positioning information request, the wireless device 302 downloads the satellite positioning information 316 through the wireless network module 314 and transmits the satellite positioning information 316 to the first short-distance transceiver module 308, and the satellite positioning module 310 generates the satellite positioning result 318 according to the received satellite positioning information 316 and the plurality of satellite signals.

For reducing the power consumption and cost as low as possible, the common wearable mobile devices at present are not capable of accessing to the internet network. In general, the positioning device 300 is paired with the wireless device 302 (e.g., smart phone). The wireless device 302 has the capabilities of performing the short-distance transmission and accessing the internet network. When the positioning device 300 has the need for positioning, the first short-distance transceiver module 308 transmits the satellite positioning information request to the wireless device 302. After the second short-distance transceiver module 312 of the wireless device 302 is paired with the positioning device 300, the wireless network module 314 is configured to request for the satellite positioning information 316 from the AGPS server. Afterward, the second short-distance transceiver module 312 transmits the satellite positioning information 316 back to the positioning device 300, such that the satellite positioning module 310 may indirectly equipped with AGPS function, and the TTFF of the positioning device 300 may be significantly decreased.

Moreover, the satellite positioning modules of the satellite positioning system 1, 2 and 3 are each equipped with the built-in processor, which may be configured to determine the deficient part of the satellite positioning information in the process of the positioning. While the satellite positioning information is received, the satellite positioning module may directly utilize the required information to improve the speed of the first fix.

In addition, in the process of the positioning of each satellite positioning module, the distance is estimated by firstly measuring the transmission time of the radio signals, and the estimated distance and the Ephemeris are then utilized to determine the positions of the satellites according to the principle of triangulation. For the estimation of the distance, the distance between the satellite positioning module and the satellite, which is also called “Pseudorange”, is calculated by multiplying the transmission time and the transmission speed of the radio signal While the satellite positioning system is utilized to measure the transmission time of the radio signal, two different clocks are necessary in the measurement. One is mounted on the satellite for recording the time when the radio signal is transmitted, and the other is mounted on the receiver for recording the time when the radio signal is received. Therefore, the time difference therebetween is the transmission time of the radio signal, and the distance between the satellite and the receiver is calculated by multiplying the transmission time and the speed of the radio signal.

On the other hand, reference is made to the books “Practical Ephemeris Calculations” by Oliver Montenbruck (Springer-Verlag, 1989, ISBN: 0387507043). and “Astronomical Algorithms” by Jean Meeus (Willmann-Bell, 1991, ISBN: 0943396352). for the definition and computation algorithm of the Ephemeris information, and the details are omitted so as not to obscure the disclosure.

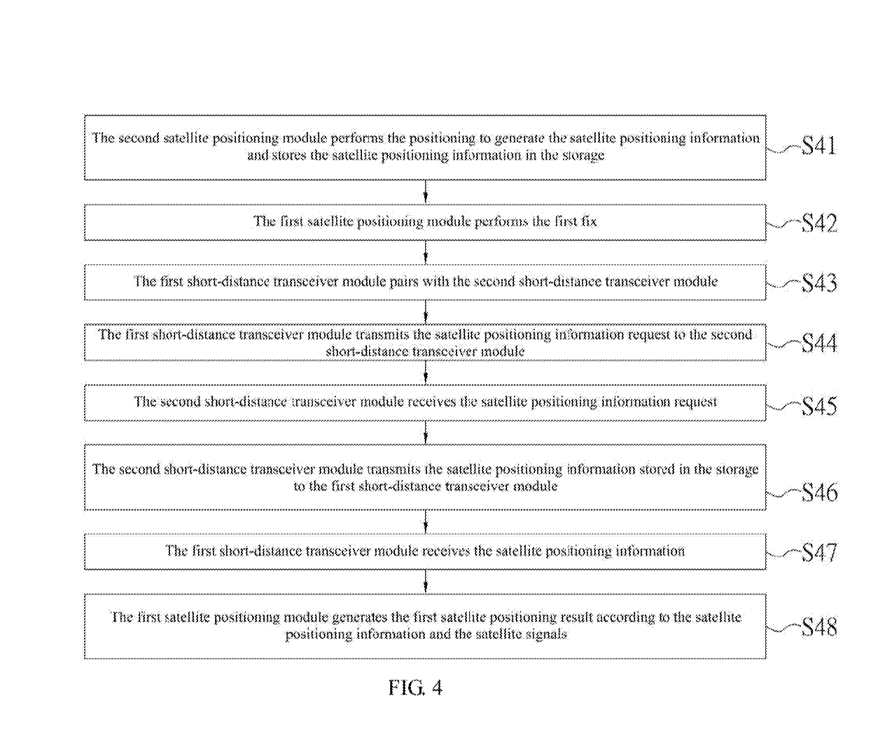

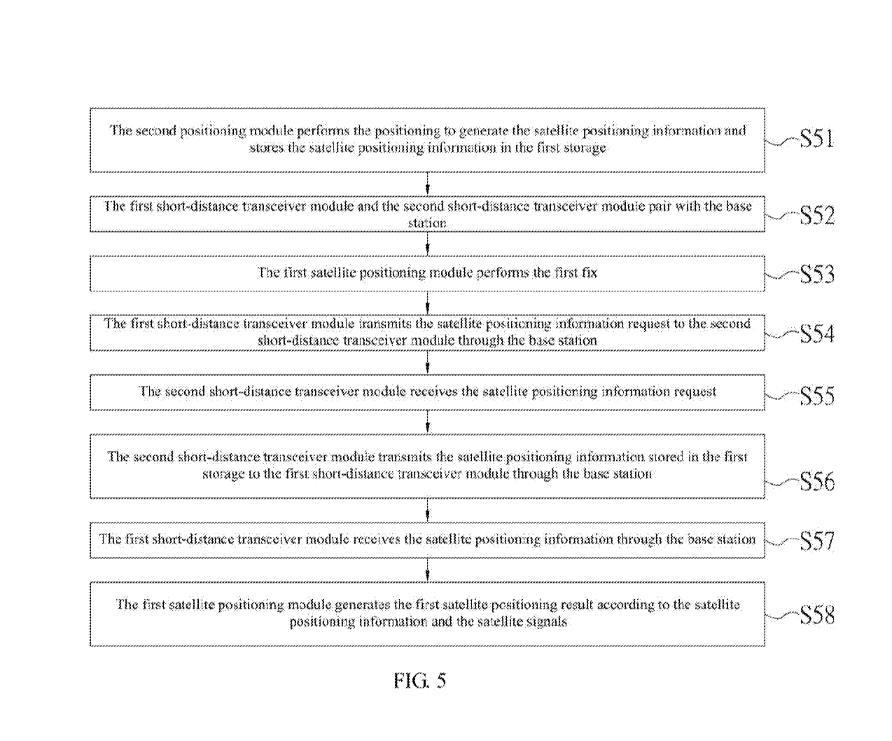

Hereinafter, the embodiments of the satellite positioning methods of the present disclosure are described in detail with reference to the accompanying drawings. Referring to both FIG. 1 and FIG. 4, FIG. 4 is a method flow chart of the satellite positioning system 1 according to the first embodiment of the present disclosure. The method includes following steps:

Step S41: First, the second satellite positioning module 108 performs the positioning to generate the satellite positioning information 114 and stores the satellite positioning information 114 in the storage 112.

Step S42: The first satellite positioning module 106 performs the first fix;

Step S43: The first short-distance transceiver module 104 pairs with the second short-distance transceiver module 108;

Step S44: The first short-distance transceiver module 104 transmits the satellite positioning information request to the second short-distance transceiver module 108;

Step S45: The second short-distance transceiver module 108 receives the satellite positioning information request;

Step S46: The second short-distance transceiver module 108 transmits the satellite positioning information 114 stored in the storage 112 to the first short-distance transceiver module 104;

Step S47: The first short-distance transceiver module 104 receives the satellite positioning information 114; and

Step S48: The first satellite positioning module 106 generates the first satellite positioning result 118 according to the satellite positioning information 114 and the satellite signals.

The TTFF of the first satellite positioning module 106 would be reduced significantly by the mentioned method.

Referring to both FIG. 2 and FIG. 5, FIG. 5 is a method flow chart of the satellite positioning system 2 according to the second embodiment of the present disclosure. The method includes the following steps:

Step S51: First, the second positioning module performs the positioning to generate the satellite positioning information 216 and stores the satellite positioning information 216 in the first storage 214;

Step S52: The first short-distance transceiver module 206 and the second short-distance transceiver module 210 pair with the base station 204;

Step S53: The first satellite positioning module 208 performs the first fix;

Step S54: The first short-distance transceiver module 206 transmits the satellite positioning information request to the second short-distance transceiver module 210 through the base station 204;

Step S55: The second short-distance transceiver module 210 receives the satellite positioning information request;

Step S56: The second short-distance transceiver module 210 transmits the satellite positioning, information 216 stored in the first storage 214 to the first short-distance transceiver module 206 through the base station 204;

Step S57: The first short-distance transceiver module 206 receives the satellite positioning information 216 through the base station 204; and

Step S58: The first satellite positioning module 208 generates the first satellite positioning result 218 according to the satellite positioning information 216 and the satellite signals.

The TTFF of the first satellite positioning module 208 would be reduced significantly and the information exchange network would be further expanded by the mentioned method. Reference is also made to the second embodiment of the satellite positioning system 2 for the detailed implementation, and the repeated description is omitted here.

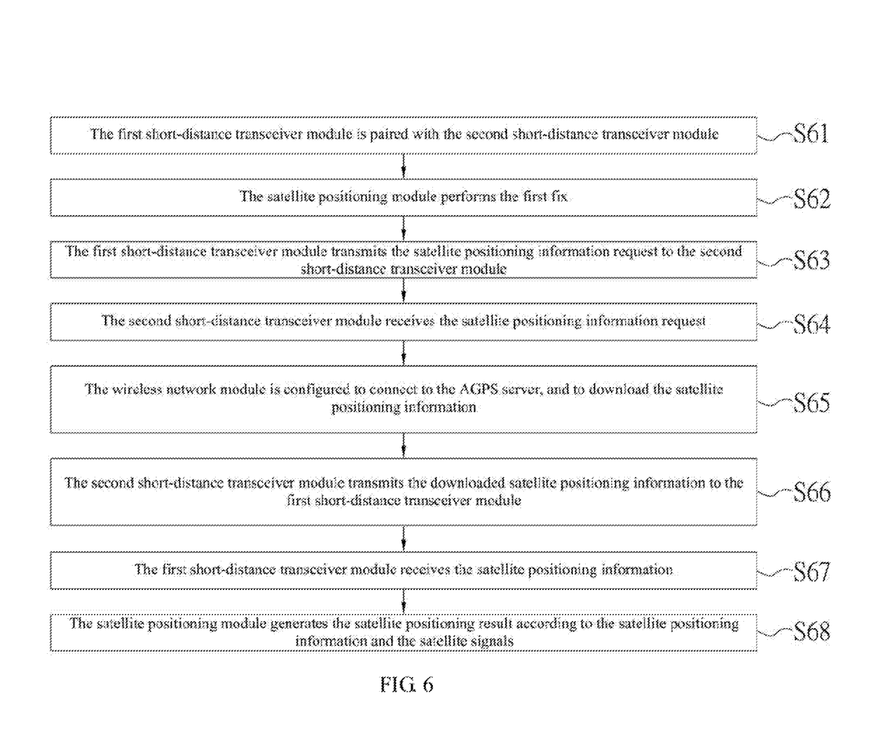

Referring, to both FIG. 3 and FIG. 6, FIG. 6 is a method flow chart of the satellite positioning system 3 according to the third embodiment of the present disclosure. The method includes following steps:

Step S61: The first short-distance transceiver module 308 is paired with the second short-distance transceiver module 312;

Step S62: The satellite positioning module 310 performs the first fix;

Step S63: The first short-distance transceiver module 308 transmits the satellite positioning information request to the second short-distance transceiver module 312;

Step S64: The second short-distance transceiver module 312 receives the satellite positioning information request;

Step S65: The wireless network module 314 is configured to connect to the AGPS server 306, and to download the satellite positioning information 316;

Step S66: The second short-distance transceiver module 312 transmits the downloaded satellite positioning information 316 to the first short-distance transceiver module 308;

Step S67: The first short-distance transceiver module 308 receives the satellite positioning information 316; and

Step S68: The satellite positioning module 310 generates the satellite positioning result 318 according to the satellite positioning information 316 and the satellite signals.

The TTFF of the satellite positioning module 310 is reduced significantly, and the positioning device 300 including the first short-distance transceiver module 308 and the satellite positioning module 310 is equipped with the function of AGPS without the capability of accessing the internet network. Reference is also made to the third embodiment of the satellite positioning system 3 for the detailed implementation, the repeated description is omitted here.

In all of the above mentioned embodiments, the first, the second, and the third short-distance transceiver modules may utilize standards such as Bluetooth, Near Field Communication (NFC), and Wi-Fi Direct to perform the wireless transmission.

Based on those mentioned above, the satellite positioning device provided by the present disclosure utilizes the short-distance transceiver modules, and the satellite positioning information or the generated satellite positioning result is used efficiently, such that the TTFF of the satellite positioning device of the present disclosure is significantly decreased, and that the satellite positioning device is provided with AGPS-like function without the capability of the global network connection. Thus the power consumption and the cost are further reduced.

Although certain preferred embodiments and methods have been disclosed herein, it will be apparent from the foregoing disclosure to those skilled in the art that variations and modifications of such embodiments and methods may be made without departing from the spirit and scope of the disclosure.

What is claimed is:

1. A satellite positioning device, comprising:
a first short-distance transceiver module, configured to wirelessly connect to a second short-distance transceiver module of an electronic device, and to receive satellite positioning information from the second short-distance transceiver module; and
a first satellite positioning module, electrically coupled to the first short-distance transceiver module, and configured to receive at least one satellite signal and to generate a first satellite positioning result according to the at least one satellite signal and the satellite positioning information received by the first short-distance transceiver module.

2. The satellite positioning device of claim 1, wherein the first short-distance transceiver module is configured to transmit a satellite positioning information request to the second short-distance transceiver module, and after the satellite positioning information is received from the second short-distance transceiver module, the first satellite positioning module generates the first satellite positioning result according to the received satellite positioning information and the at least one satellite signal.

3. The satellite positioning device of claim 1, wherein the first satellite positioning module generates the first satellite positioning result within a valid time of the satellite positioning information.

4. The satellite positioning device of claim 1, wherein the first short-distance transceiver module further receives a second satellite positioning result from the second short-distance transceiver module, in which the second satellite positioning result is generated by the electronic device, and the first satellite positioning module utilizes the second satellite positioning result to serve as the first satellite positioning result.

5. The satellite positioning device of claim 4, wherein the first satellite positioning module utilizes the second satellite positioning result to serve as the first satellite positioning result if the second satellite positioning result is within a valid time period of the second satellite positioning result.

6. The satellite positioning device of claim 1, wherein the first short-distance transceiver module receives the satellite positioning information generated by a wireless network module of the electronic device from the second short-distance transceiver module, and the wireless network module receives the satellite positioning information from an assisted global positioning system (AGPS) server.

7. An electronic device, configured to assist a satellite positioning device to generate a first satellite positioning result according to at least one first satellite signal, the satellite positioning device having a first short-distance transceiver module and a first satellite positioning module coupled to each other, wherein the electronic device comprises:
a second satellite positioning module, configured to receive at least one second satellite signal to generate satellite positioning information; and
a second short-distance transceiver module, configured to transmit the satellite positioning information to the first short-distance transceiver module;
wherein the first satellite positioning module generates a first satellite positioning result according to the at least one first satellite signal and the satellite positioning information received by the first short-distance transceiver module.

8. The electronic device of claim 7, wherein the second satellite positioning module is further configured to generate a second satellite positioning result, and the second short-distance is further configured to transmit the second satellite positioning result generated by the second satellite positioning module to the first short-distance transceiver module, such that the first satellite positioning module directly utilizes the second satellite positioning result to serve as the first satellite positioning result.

9. An electronic device, configured to assist a satellite positioning device to generate a first satellite positioning result according to at least one first satellite signal, the satellite positioning device having a first short-distance transceiver module and a first satellite positioning module coupled to each other, wherein the electronic device comprises:
a wireless network module, configured to receive satellite positioning information generated by another electronic device; and
a second short-distance transceiver module, configured to transmit the satellite positioning information to the first short-distance transceiver module;
wherein the first satellite positioning module generates the first satellite positioning result according to the at least one first satellite signal and the satellite positioning information received by the first short-distance transceiver module.

10. The electronic device of claim 9, wherein the first short-distance transceiver module is configured to transmit a first satellite positioning information request to the second short-distance transceiver module, and after the second short-distance transceiver module receives the first satellite positioning information request, the second short-distance transceiver module is configured to transmit the satellite positioning information received by the wireless network module to the first short-distance transceiver module, and the first satellite positioning module generates the first satellite positioning result according to the satellite positioning information and the at least one first satellite signal.
